(19) United States
(12) Patent Application Publication
(10) Pub. No.: US 2026/0188146 A1
(43) Pub. Date: Jul. 2, 2026

(54) ILLUMINATED ADDRESS IDENTIFICATION SIGN

(71) Applicant: John Mitchell, Pueblo, CO (US)

(72) Inventor: John Mitchell, Pueblo, CO (US)

(21) Appl. No.: 19/002,041

(22) Filed: Dec. 26, 2024

(51) Int. Cl. G09F 13/04; G09F 7/18

(52) U.S. Cl. CPC G09F 13/0404; G09F 7/18; G09F 13/0445; G09F 2007/1873

(57) ABSTRACT

An illuminated address identification sign includes a housing and a plurality of sculpted alphanumeric characters. The housing includes a back wall and a perimeter wall. The perimeter wall extends perpendicularly from the back wall. The perimeter wall includes a lip defining a front aperture into an interior space in the housing. The plurality of sculpted alphanumeric characters is removably mounted in the housing and extending across the front aperture. A light is coupled to the housing. The light is designed to illuminate the interior space and backlight the sculpted alphanumeric characters. A solar panel is coupled to the housing. The solar panel is connected to the light to supply power to the light.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to address signs and more particularly pertains to a new illuminated address identification sign for providing a customizable address sign that is easier to see in dark conditions. Most address signs have fixed number plates that can be illuminated. The new illuminated address identification sign has interchangeable sculpted or three-dimensional alphanumeric characters that are backlit by a light to provide high contrast for easier viewing of the numbers.

### (2) Description of Related Art Including Information Disclosed Under 37 CFR 1.97 and 1.98

The prior art relates to illuminated boxes and panels that use LED lights or incandescent bulbs to illuminate a plate or multiple plates that have a house number printed thereon. Some are solar powered. The prior art, as best understood, does not disclose an address identification sign that has a box-shaped housing and individual sculpted numbers having top and bottom slide members slidably mounted in top and bottom guide tracks in the front of the box-shaped housing. A solar-powered light is positioned in the housing to backlight the sculpted numbers.

### (H) BRIEF SUMMARY OF THE INVENTION

An embodiment of the disclosure meets the needs presented above in a illuminated address identification sign generally comprising a housing and a plurality of sculpted alphanumeric characters. The housing includes a back wall and a perimeter wall. The perimeter wall extends perpendicularly from the back wall. The perimeter wall includes a lip defining a front aperture into an interior space in the housing. The plurality of sculpted alphanumeric characters is removably mounted in the housing and extending across the front aperture. A light is coupled to the housing. The light is designed to illuminate the interior space and backlight the sculpted alphanumeric characters. A solar panel is coupled to the housing. The solar panel is connected to the light to supply power to the light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of an illuminated address identification sign according to an embodiment of the disclosure.

FIG. 2 is a rear perspective view of an embodiment of the disclosure.

FIG. 3 is an exploded view of an embodiment of the disclosure.

FIG. 4 is a front view of an embodiment of the disclosure in use.

### (J) DETAILED DESCRIPTION OF THE INVENTION

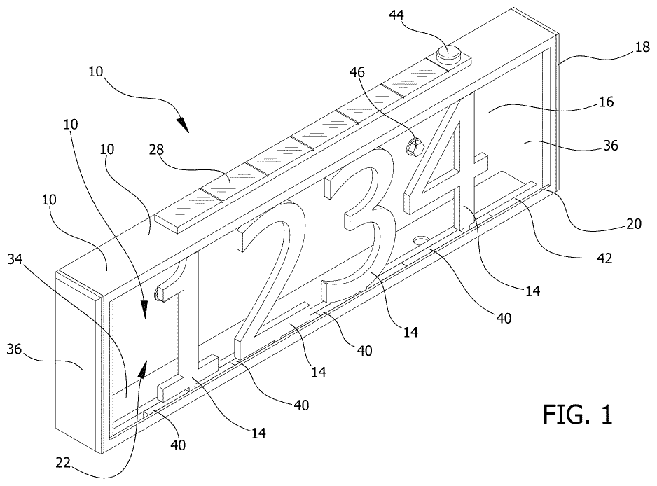

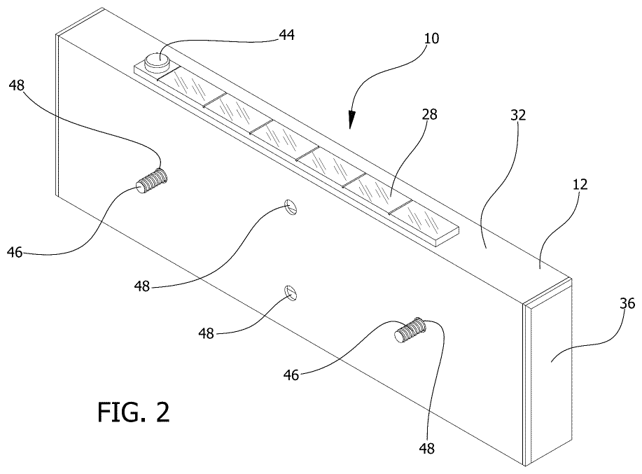

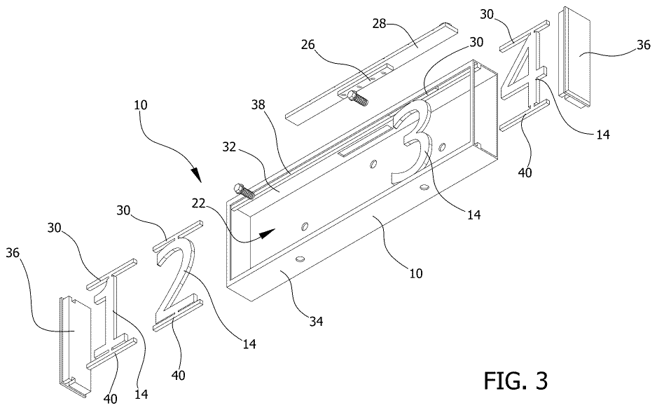

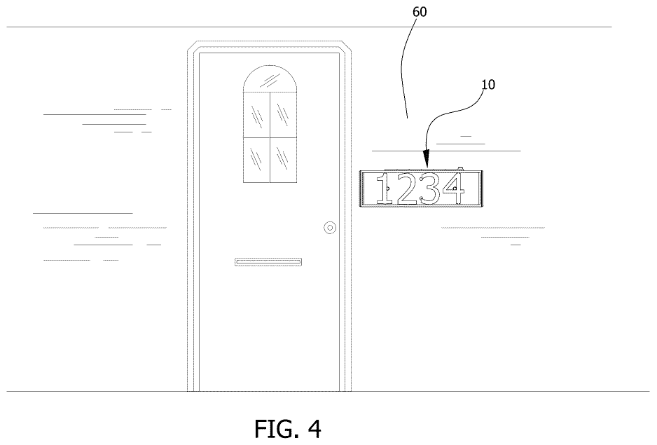

With reference now to the drawings, and in particular to FIGS. 1 through 4 thereof, a new illuminated address identification sign embodying the principles and concepts of an embodiment of the disclosure and generally designated by the reference numeral 10 will be described.

As best illustrated in FIGS. 1 through 4, the illuminated address identification sign 10 generally comprises a housing 12 and a plurality of sculpted alphanumeric characters 14. The housing 12 includes a back wall 16 and a perimeter wall 18. The perimeter wall 18 extends perpendicularly from the back wall 16. The perimeter wall 18 includes a lip 20 defining a front aperture 22 into an interior space 24 in the housing 12. The sculpted alphanumeric characters 14 are removably mounted in the housing 12 and extend across the front aperture 22. A light 26 is coupled to the housing 12. The light 26 is designed to illuminate the interior space 24 and backlight the sculpted alphanumeric characters 14. A solar panel 28 is coupled to the housing 12. The solar panel 28 is connected to the light 26 to supply power to the light 26.

The illuminated address identification sign 10 further includes a plurality of top slide bars 30. Each of the top slide bars 30 is attached to an upper end of a respective one of the sculpted alphanumeric characters 14. The perimeter wall 18 includes a top panel 32, a bottom panel 34, and a pair of lateral panels 36 connecting the top panel 32 and the bottom panel 34. The top panel 32 includes a top slot 38 positioned along a length of the top panel 32. Each of the top slide bars 30 is movably positioned in the top slot 38.

The illuminated address identification sign 10 further includes a plurality of bottom slide bars 40. Each of the bottom slide bars 40 is attached to a lower end of a respective one of the sculpted alphanumeric characters 14. The bottom panel 34 includes a bottom slot 42 positioned along a length of the bottom panel 34. Each of the bottom slide bars 40 is movably positioned in the bottom slot 42. In at least one possible embodiment, either the top slide bars 30 or the bottom slide bars 40 could be omitted as the sculpted alphanumeric characters 14 could be supported from either the upper end or the lower end.

At least one of the lateral panels 36 is removable to open the top slot 38 and the bottom slot 42 such that the sculpted alphanumeric characters 14 are slidable into and out of the housing 12. In the exemplary embodiment, both of the lateral panels 36 are removable. In another possible embodiment, the later panels are not removable and the top panel 32 has an opening to allow the sculpted alphanumeric characters 14 to be inserted and removed upwardly.

The solar panel 28 is mounted on an exterior surface of the top panel 32. The light 26 is coupled to the top panel 32 and positioned facing into the interior space 24. In another possible embodiment, the light 26 could be coupled in different positions on the housing 12. The solar panel 28 could also be mounted on the lateral panels 36.

The illuminated address identification sign 10 further includes a power switch 44 that is connected to the light 26 and designed to selectively turn the light 26 on and off. In another possible embodiment, a light-activated sensor could be attached to the housing 12 to automatically turn the light 26 on in dark environments.

The illuminated address identification sign 10 further includes a plurality of securing elements 46, such as screws or bolts, designed to be inserted into a support structure, such as a building or house. The back wall 16 includes a plurality of openings 48. Each of the openings in the back wall 16 is designed to receive a respective one of the securing elements 46 to mount the housing 12 onto the support structure with the back wall 16 abutting the support structure. The housing 12 could be attached by essentially any mechanical securing elements 46 as are well known.

The housing 12 is designed to hold up to six sculpted alphanumeric characters 14. In the exemplary embodiment, the housing 12 has a width in the range of 16 to 22 inches, a height in the range of 4 to 9 inches, and a depth in the range 1 to 3 inches. In other possible embodiments, the housing 12 could be larger or smaller and could be designed to hold more or fewer than six sculpted alphanumeric characters 14.

The illuminated address identification sign 10 is used to mark a building, such as a house 60 or a commercial building. The sculpted alphanumeric characters 14 are removable to allow a person to customize the sign 10 as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An illuminated address identification sign comprising:
a housing including a back wall and a perimeter wall, said perimeter wall extending perpendicularly from said back wall, said perimeter wall including a lip defining a front aperture into an interior space in said housing;
a plurality of sculpted alphanumeric characters being removably mounted in said housing and extending across said front aperture;
a light being coupled to said housing, said light being configured to illuminate said interior space and backlight said sculpted alphanumeric characters; and
a solar panel being coupled to said housing, said solar panel being connected to said light to supply power to said light.

2. The illuminated address identification sign of claim 1, further including a plurality of top slide bars, wherein:
each of said top slide bars is attached to an upper end of a respective one of said sculpted alphanumeric characters;
said perimeter wall includes a top panel, a bottom panel, and a pair of lateral panels connecting said top panel and said bottom panel;
said top panel includes a top slot positioned along a length of said top panel; and
each of said top slide bars is movably positioned in said top slot.

3. The illuminated address identification sign of claim 1, further including a plurality of bottom slide bars, wherein:
each of said bottom slide bars is attached to a lower end of a respective one of said sculpted alphanumeric characters;
said perimeter wall includes a top panel, a bottom panel, and a pair of lateral panels connecting said bottom panel and said bottom panel;
said bottom panel includes a bottom slot positioned along a length of said bottom panel; and
each of said bottom slide bars is movably positioned in said bottom slot.

4. The illuminated address identification sign of claim 2, further including a plurality of bottom slide bars, wherein:
each of said bottom slide bars is attached to a lower end of a respective one of said sculpted alphanumeric characters;
said bottom panel includes a bottom slot positioned along a length of said bottom panel; and
each of said bottom slide bars is movably positioned in said bottom slot.

5. The illuminated address identification sign of claim 4, wherein at least one of said lateral panels is removable to open said top slot and said bottom slot such that said sculpted alphanumeric characters are slidable into and out of said housing.

6. The illuminated address identification sign of claim 1, wherein said solar panel is mounted on an exterior surface of said top panel.

7. The illuminated address identification sign of claim 1, wherein said light is coupled to said top panel and positioned facing into said interior space.

8. The illuminated address identification sign of claim 1, further comprising a power switch being connected to said light and configured to selectively turn said light on and off.

9. The illuminated address identification sign of claim 1, further comprising a plurality of securing elements configured to be inserted into a support structure, wherein:
said back wall includes a plurality of openings; and
each of said openings in said back wall is configured to receive a respective one of said securing elements to mount said housing onto the support structure with said back wall abutting the support structure.

10. The illuminated address identification sign of claim 1, wherein said housing is configured to hold up to six sculpted alphanumeric characters.

11. The illuminated address identification sign of claim 1, wherein said housing has a width in the range of 16 to 22 inches, a height in the range of 4 to 9 inches, and a depth in the range 1 to 3 inches.

12. The illuminated address identification sign of claim 5, wherein said solar panel is mounted on an exterior surface of said top panel.

13. The illuminated address identification sign of claim 12, wherein said light is coupled to said top panel and positioned facing into said interior space.

14. The illuminated address identification sign of claim 13, further comprising a power switch being connected to said light and configured to selectively turn said light on and off.

15. The illuminated address identification sign of claim 14, further comprising a plurality of securing elements configured to be inserted into a support structure, wherein:
said back wall includes a plurality of openings; and
each of said openings in said back wall is configured to receive a respective one of said securing elements to mount said housing onto the support structure with said back wall abutting the support structure.

16. The illuminated address identification sign of claim 15, wherein said housing is configured to hold up to six sculpted alphanumeric characters.

17. The illuminated address identification sign of claim 16, wherein said housing has a width in the range of 16 to 22 inches, a height in the range of 4 to 9 inches, and a depth in the range 1 to 3 inches.
